(19) United States
(12) Patent Application Publication
(10) Pub. No.: US 2009/0085736 A1
(43) Pub. Date: Apr. 2, 2009

(54) Left and right front side panel vehicle safety brake lights patent application

(76) Inventor: Thomas W. Hyatt, Fredericktown, MO (US)

Correspondence Address: Thomas W. Hyatt, 2921 Highway C, Fredericktown, MO, 63645, US

(21) Appl. No.: 11/904,951

(22) Filed: Oct. 1, 2007

(51) Int. Cl. B60Q 1/44

(52) U.S. Cl. 340/479

(57) ABSTRACT

Left and Right Front Side Panel Vehicle Safety Brake Lights will provide motorists approaching from either direction a visual indicator of the use of, and continued application of, the brakes on any vehicle that is about to enter or cross the flow of traffic. At present, there is no way for oncoming motorists to know whether such vehicles have brakes activated or not. Motorists partially cross a divided highway at speeds that suggest they might keep going; vehicles stick out into the lane of oncoming traffic; motorists appear distracted by cellular telephones, grooming or external stimuli; they simply aren't looking; or visibility is limited due to road curvatures, hills, or weather conditions. The visual indicator of the front side panel brake lights will alert oncoming motorists if vehicles awaiting entry into the flow of traffic are braking, or if they are about to pull out in front of oncoming traffic.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

In the automobile manufacturing industry, this invention addresses the problem of uncertainty experienced by motorists approaching a vehicle waiting to pull out into the flow of traffic, either to enter a roadway or to cross it.

### BRIEF SUMMARY OF THE INVENTION

Left and Right Front Side Panel Vehicle Safety Brake Lights provide motorists approaching from either direction a visual indicator regarding the use of, and continued application of, brakes by motorists of any vehicle attempting to enter or cross a low-to-medium speed roadway or a high-speed highway.

This visual indicator allows motorists already on the roadway or the highway the opportunity to make an informed decision appropriate to the situation when approaching all vehicles waiting to enter or cross the flow of traffic. For instance, when the front side panel brake light on a vehicle attempting entry is not lit, or when it had been lit and has now gone off, this alerts motorists already on the roadway or the highway to use appropriate caution.

This visual indicator of applied brakes affords certainty for motorists already in the flow of traffic.

This visual indicator will reduce the number of collisions, injuries and fatalities on roadways and highways.

### BRIEF DESCRIPTION OF THE SEVERAL VIEWS OF THE DRAWING

FIG. 1A depicts the Left Front Side Panel Vehicle Safety Brake Light.

FIG. 1B depicts the Right Front Side Panel Vehicle Safety Brake Light.

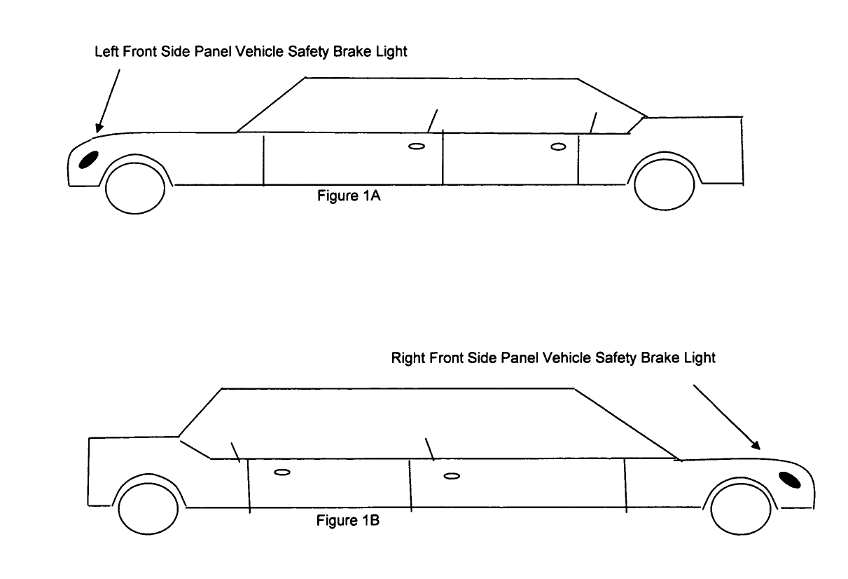

### DETAILED DESCRIPTION OF THE INVENTION

Brake lights are installed on both left and right front side panels of vehicles.

These front side panel brake lights are wired to the braking system in the exact same way that existing rear brakes are wired to the braking system, with identical circuitry.

Depression of the brake pedal closes the electrical circuit, which transmits an electrical current to activate the front side panel brake lights.

Left and Right Front Side Panel Vehicle Safety Brake Lights transmit a constant glow through red, translucent plastic covers during the entire time that the brake pedal is depressed, identical to existing rear brake technology.

1. The primary object of this patent application is the idea itself, and not the existing hardware to implement the idea, which is the installation of brake lights at both left and right front panels of vehicles to provide certainty and improved safety to all motorists in circumstances involving vehicles waiting to enter or cross the flow of traffic on all roadways and highways.
This idea involves the use of existing hardware, applied in new locations on vehicles, in order to fulfill the specifications of this idea, as listed in the following items:
Wiring from the existing braking system's circuitry, extending to the extreme front end of both left and right front panels on vehicles.
A single brake light fixture, made of metal or plastic, attached to the above wiring and installed into, or affixed onto, the metal or fiberglass front panel on both of the left and right sides of vehicles.
The fixture includes a standard brake light bulb; and a red, translucent plastic cover through which the light bulb's glow is visible and translated as “red” by the human eye.
